(19) United States
(12) Patent Application Publication
(10) Pub. No.: US 2005/0203655 A1
(43) Pub. Date: Sep. 15, 2005

(54) Scheduling system and method for avoiding low equipment utilization

(75) Inventor: Hsin-Chen Tsai, Yunlin County (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co.

(21) Appl. No.: 10/798,670

(22) Filed: Mar. 11, 2004

(51) Int. Cl. G06F 19/00

(52) U.S. Cl. 700/101

(57) ABSTRACT

A manufacturing equipment scheduler controls the run sequences of product lots to minimize low utilization rates of units of manufacturing equipment within a manufacturing facility. The manufacturing equipment scheduling system includes a product lot sequence controller that receives priority information of the product lots dispatched for fabrication The product lot sequence controller determines a priority of a currently dispatched product lot. If the current product lot has a high priority, the product lot sequence controller then determines if a previous product lot remains in a selected unit of processing equipment and has a normal priority. If the previous product lot has a normal priority, the product lot is removed from the selected unit of processing equipment and the product lot with the high priority is processed. Upon completion of processing the current product lot with high priority, processing for the previous product lot is continued.

### BACKGROUND OF THE INVENTION

1. Field of the Invention

This invention relates generally to a computer integrated manufacturing systems and methods. More particularly, this invention relates to computer integrated manufacturing systems and methods for scheduling dispatching of lots of product to units of manufacturing equipment for fabrication. Even more particularly, this invention relates to computer integrated manufacturing systems and methods for dispatching lots of product with high priority while avoiding low utilization of the units of manufacturing equipment.

2. Description of Related Art

In firms such as semiconductor fabrication companies commonly referred to as silicon foundries, there are numerous factories at various locations. Each of the factories may have multiple fabrication lines, employing different sets of processing equipment. Currently most fabrication lines are highly automated and controlled by computer integrated manufacturing systems (CIM). The CIM system receives dispatch scheduling information regarding the product to be manufactured from a marketing and sales database. From the dispatch scheduling information, the CIM schedules the necessary processing equipment and distribution of the raw materials. The CIM then starts the manufacturing process and provides monitoring of the processing equipment.

Certain customers of a manufacturing enterprise negotiate higher priority for fabrication of certain lots of product. Or committed schedule may require that certain lots of product must be granted a higher priority. These priorities are commonly referred to as “Hot Lots” or “Super Hot Lots” and require that their progress through a manufacturing facility be unimpeded Often this requires that lots having a normal priority be held up as soon as a “Super Hot Lot” is scheduled for dispatch to a unit of manufacturing equipment. Refer now to FIG. 1 for a discussion of the dispatch and scheduling of lots of product within a manufacturing facility. The manufacturing facility, as illustrated, is a semiconductor foundry which processes lots of substrates wafers 10 and 20. The units of manufacturing equipment 5 and 50 are such equipment as etchers, diffusion ovens, sputtering deposition units, etc. The normal lots of substrates 20 are processed by the first unit of manufacturing equipment (i.e. a substrate surface cleaning unit) 5 and transferred 30 the normal lots to a queuing area 25 awaiting processing by a second unit of manufacturing equipment (i.e. a sputtering unit) 20. However, if a “Super Hot Lot” of product lot 10 arrives for processing at the first unit of manufacturing equipment 5, the operator 15 must restrict the transfer of the normal lots 20 to the second unit of manufacturing equipment 50. The second unit of equipment 50 then remains idle until the operator 15 receives 35 the “Super Hot Lot” of product 10 from the first unit of manufacturing equipment 5. The operator then places 45 the “Super Hot Lot” of product 10 in the second unit of manufacturing equipment 50 for processing. The normal lots of product 20 have now been idle while the “Super Hot Lot” of product 10 is in transit and in the second unit of manufacturing equipment 50.

Refer now to FIG. 2 for a discussion of the utilization rate of the scheduling of the “Super Hot Lot” of product 10 of FIG. 1. At the notification 100 of that the “Super Hot Lot” of product 10 is being dispatched. The second unit of manufacturing equipment is set to idle and the normal priority lots are waiting 105. In this example, the waiting time 110 is for 30 minutes. At the arrival of the “Super Hot Lot” of product 10, the second unit of manufacturing equipment processes the “Super Hot Lot” of product 10 for 46 minutes 120. Further, in this example, the next lot of product to be processed is placed in the second unit of manufacturing equipment approximately six minutes prior to the exit of the previous lot of product, in this example the “Super Hot Lot” of product 10. Thus the time for processing the next lot of product, which is 46 minutes, overlaps the processing of the “Super Hot Lot” of product 10 and therefore the elapsed time 130 of the next lot is 40 minutes. Similarly, the second normal lot 135 is placed in the second unit of manufacturing equipment six minutes prior to the ending of the first normal lot 125. The elapsed time 140 of the second normal lot of product is also 40 minutes.

The total time 145 for processing the three lots of product is 156 minutes. Each lot of product contains 25 wafer substrates, therefore 75 wafers are processed in the 156 minutes. It can be shown that the utilization rate is 126/156 or 80.76% and that the throughput is 28 wafers per hour (75 wafers/(156 minutes/60 minutes)).

U.S. Pat. No. 5,818,716 (Chin, et al.) describes a dispatching algorithm for a semiconductor manufacturing fabrication plant with production to-order type operation. The dispatching algorithm functions according to the level of current wafers in process (WIP). The dispatching algorithm revises the due date for every lot to satisfy the demand from Master Production Scheduling (MPS). Further the dispatching algorithm calculates the required turn rate of each lot based on process flow to fulfill the delivery requirement. The dispatching algorithm determines not only due date and production priority of each lot, but also provides required turn rate for local dispatching. The local dispatching systems of each working area dispatch the lots by using required turn rate to maximize output and machines utilization.

U.S. Pat. No. 5,737,728 (Sisley, et al.) illustrates a system and method for assigning and scheduling resource requests to resource providers using a modified “best-first” search technique that combines optimization, artificial intelligence, and constraint-processing to arrive at near-optimal assignment and scheduling solutions. In response to changes in a dynamic resource environment, potential changes to an existing assignment set are evaluated in a search for a better solution. New calls are assigned and scheduled as they are received, and the assignment set is readjusted as the field service environment changes, resulting in global optimization. Each search operation is in response to either an incremental change to the assignment set such as adding a new resource request, removing a pending resource request, reassigning a pending resource request, or to a request for further evaluation. Thus, the search technique assumes that the existing assignment set is already optimized, and limits the task only to evaluating the effects of the incremental change. In addition, each search operation produces a complete assignment and scheduling solution. Consequently, the search can be terminated to accept the best solution generated so far, making the technique an “anytime” search.

U.S. Pat. No. 5,548,518 (Dietrich, et al.) teaches a novel allocation method for generating a feasible production schedule. The method, in response to a specified requirement first determines what quantity of a product can be produced with a specified quantity of supply components. The method then allocates a required quantity of supply components for filling a thus defined partial order; and then fills a remainder of the requirement at some later time.

U.S. Pat. No. 5,291,394 (Chapman) describes a system and process for allowing virtual allocations of resources to lots to closely mimic actual allocations of resources to lots. Virtual allocations represent planned or scheduled allocations of an organization's resources to produce various products. Actual allocations represent the actual course of events which occur while the product is being manufactured. A manufacturing interpreter interactively functions with an expert in a manufacturing environment to produce a comprehensive and accurate definition of resources utilized in a manufacturing environment. The manufacturing interpreter further allows the expert to define a comprehensive and accurate process flow description for various products. The process flow description specifies the resources, resource attribute capabilities, and order for applying resources to a single lot to produce a completed product. A planner operates upon this process flow data to generate a processing plan that is specifically adapted for the organization at a particular point in time, and an execution controller utilizes the processing plan to control the manufacturing of products within the manufacturing environment. Operation of the execution controller keeps allocation data current. Thus, the planner has current allocation data with which to merge process flow data for new products.

U.S. Pat. No. 5,040,123 (Barber, et al.) illustrates an expert system scheduler that uses heuristics developed by an experienced factory scheduler. The scheduler uses these heuristics to generate schedules. Forward and backward scheduling is used at different stages of the schedule generation process.

U.S. Pat. No. 5,841,677 (Yang, et al.) details a lot dispatching method and apparatus for dispatching WIP lots in the manufacture of semiconductor integrated circuits. The method includes determining an average process time and average number of lots per batch of a succeeding process, and determining allowable lots of a preceding process. The allowable lots is equal to the preceding lots undergoing the preceding process to the extent that the sum of and the lots waiting to undergo the succeeding process is not greater than the maximum batch size of the succeeding process. An allowable waiting time is then determined in accordance with a lot waiting rule, where the allowable waiting time represents the average time for processing the number of additional lots to be gained by waiting for the preceding process to complete. If the expected waiting time for the preceding process to complete is greater than the determined allowable waiting time, the WIP lots are immediately processed in the succeeding process; otherwise, the WIP lots are not dispatched until the allowable lots of the preceding process arrive, which are then combined into a single batch and dispatched into the succeeding process.

### SUMMARY OF THE INVENTION

An object of this invention is to provide a manufacturing equipment scheduler that controls the run sequences of product lots to minimize low utilization rates of units of manufacturing equipment within a manufacturing facility.

In order to accomplish at least this object, a manufacturing equipment scheduling system includes a product lot sequence controller. The product lot sequence controller is in communication with a product lot dispatch system to receive priority information of the product lots dispatched for fabrication. The product lot sequence controller is further in communication with an operations controller to establish an order in which the product lots are processed by units of the processing equipment. The product lot sequence controller establishes the order by first receiving a dispatch order for at least one current product lot. The product lot sequence controller then determining a priority of the current product lot. If the current product lot has a high priority, the product lot sequence controller then determines if a previous product lot remains in a selected unit of processing equipment. If the previous product lot is remaining in the selected unit processing equipment, the product lot sequence controller determines if the previous product lot is has a normal priority. If the previous product lot has a normal priority, the product lot is removed from the selected unit of processing equipment and the product lot with the high priority is processed. Upon completion of processing the current product lot with high priority, processing for the previous product lot is continued

The product lot sequence controller further establishing the order by determining if the previous product lot remains in the selected unit of processing equipment, if the current product lot has the normal priority. If the previous product lot is remaining in the selected unit of processing equipment, the processing of the previous product lot continues to completion. Upon completion of the previous product lot, the processing the current product lot with the normal priority is initiated.

The product lot sequence controller further establishes the order by determining if the previous product lot remains in the selected unit of processing equipment, if the current product lot has the high priority. If the previous product lot is remaining in the selected unit of processing equipment has a high priority, continuing processing the previous product to completion. Upon completion of processing the previous product lot, processing the current product lot with the high priority.

The removing the previous product lot from the selected unit of processing equipment begins by commanding the selected unit of processing to cease processing the previous lot. The status information of all pieces of product within the product lot is recorded. The selected unit of processing equipment is then instructed to return the previous product lot to a staging location.

The continuing processing of the previous product begins by examining status information of all pieces of product within the product lot. The selected unit of processing equipment is instructed to acquire the previous product lot from the staging location and then commanded to continue processing the previous lot.

The manufacturing equipment scheduling system further includes a messaging facility The messaging facility is connected to communicate messages between the product lot sequence controller, the units of the processing equipment, and product lot dispatch system.

In an embodiment of this invention, the product lots are integrated circuit substrates or wafers and the units of the processing equipment are integrated circuit fabrication equipment.

### BRIEF DESCRIPTION OF THE DRAWINGS

FIG. 1 is a diagram illustrating the flow of lots of product between units of manufacturing processing equipment illustrating the handling lots having high priority of the prior art.

FIG. 2 is timing diagram illustrating the utilization of a unit of manufacturing processing equipment in processing lots of product with high priority.

FIG. 3 is diagram of a manufacturing facility having a scheduling and dispatch system for controlling run sequences of product lots to minimize low utilization rates of units of manufacturing processing equipment of this invention.

FIG. 4 is a diagram illustrating the flow of lots of product between units of manufacturing processing equipment illustrating the handling lots having high priority of this invention.

FIG. 5 is timing diagram illustrating the utilization of a unit of manufacturing processing equipment in processing lots of product with high priority by controlling run sequences of product lots to minimize low utilization rates of units of manufacturing processing equipment of this invention.

FIGS. 6 and 7 are flow diagrams for a process executed by a software agent for controlling run sequences of product lots to minimize low utilization rates of units of manufacturing processing equipment of this invention.

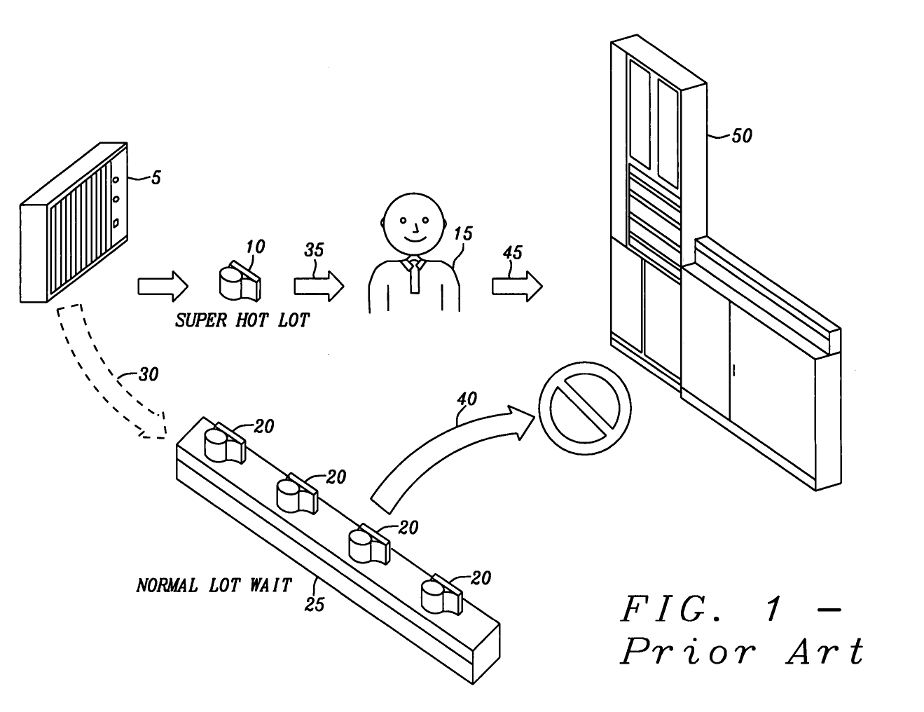

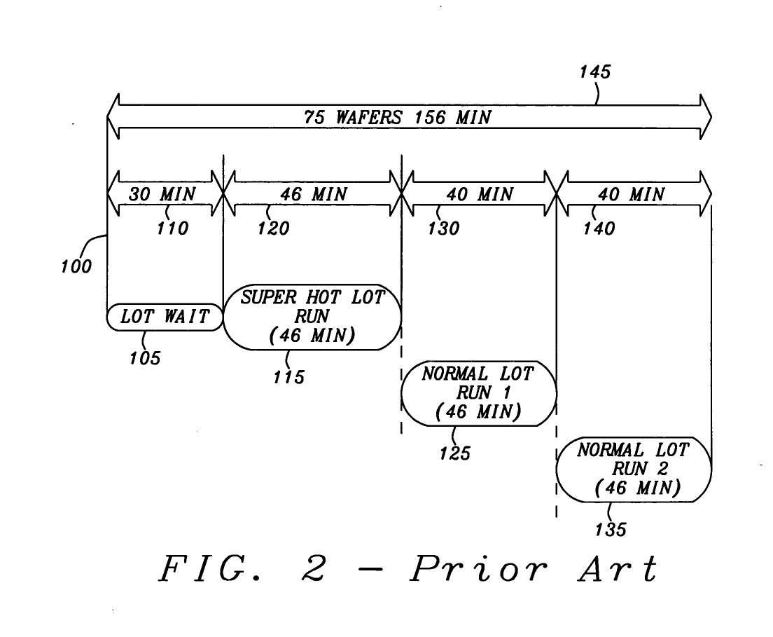

### DETAILED DESCRIPTION OF THE INVENTION

A scheduling and dispatch controller of a computer integrated manufacturing system executes a program or software agent that schedules manufacturing equipment to control run sequences of product lots to minimize low utilization rates of units of manufacturing processing equipment employed in fabricating the product lots. The program process executed by the software agent begins by communicating with a product lot dispatch system to receive priority information of the product lots dispatched for fabrication and communicating with an operations controller to establish an order in which the product lots are processed by units of the processing equipment. The order of the product lots in processing is established by receiving a dispatch order a current product lot with its priority. If the current product lot has a high priority, it must be determined whether a previous product lot remains in a unit of processing equipment. It there is a previous product lot remaining in the unit of processing equipment, it must be determined whether the previous product lot is has a normal priority. If the previous product lot has a normal priority, the previous product lot is removed from the selected unit of processing equipment and the current high priority product lot is processed Upon completion of processing the current high priority product lot, the unit of manufacturing processing equipment continues processing the previous normal priority product lot to completion.

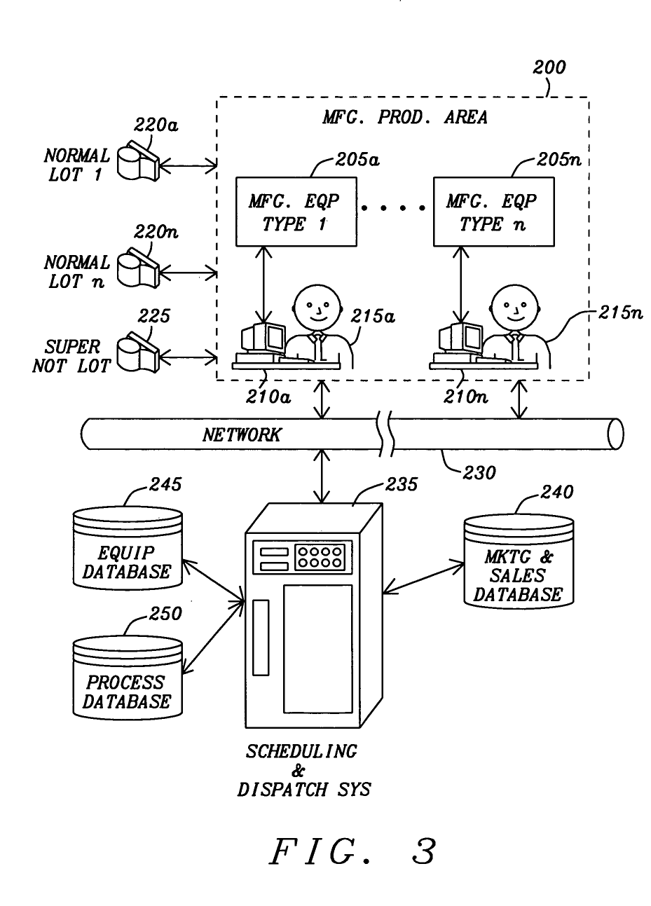

Refer to FIG. 3 for a description of the computer integrated manufacturing system having the program or software agent that schedules manufacturing equipment to control run sequences of product lots to minimize low utilization rates of units of manufacturing processing equipment employed in fabricating the product lots. The manufacturing production area 200 has multiple units of manufacturing equipment 205a, . . . , 205n which perform the processing steps of the recipes for each stage of the procedures for processing a lot of manufactured product lots. In an integrated circuit fabrication facility or silicon foundry, the units of manufacturing equipment 205a, . . . , 205n are etchers, diffusion oven, sputtering deposition units, substrate surface cleaning units, etc.

The multiple units of manufacturing equipment 205a, . . . , 205n are each connected to a manufacturing execution system operator console 210a, . . . , 210n. The manufacturing execution system operator console 210a, . . . , 210n is connected to receive sensor information describing the operation status of each of the multiple units of manufacturing equipment 205a, . . . , 205n and to transmit necessary operation control commands to each of the multiple units of manufacturing equipment 205a, . . . , 205n. An operator monitors each of the manufacturing execution system operator consoles 210a, . . . , 210n to coordinate the function of each of the multiple units of manufacturing equipment 205a, . . . , 205n. The manufacturing execution system operator consoles 210a, . . . , 210n are connected with the messaging network 230 to communicate with the computer integrated manufacturing system (CIM) 235. The CIM system 235 is retrieves the necessary process instruction from the process database 250 and the equipment allocations and locations from the equipment database 245. When an order for product is recorded in the marketing and sales database 240, the CIM system 235 is alerted to the order. The order includes a committed delivery schedule and any committed priority that is granted to the customer. The CIM system 235 separates the order into the number of manufacturing product lots required in the fabrication of the product. The CIM system 235 then assigns a priority to each of the manufacturing product lots. The manufacturing product lots 220a, . . . , 220n, and 225 are then dispatched to the manufacturing production area 200. Those manufacturing product lots 220a, . . . , 220n that are committed to delivery in a time that allows for normal processing through the manufacturing production area 200 are assigned a normal priority. Alternately, those manufacturing product lots 225 that require immediate processing are assigned a hot or super hot priority.

The CIM system 235 provides a scheduling and dispatch function that determines the allocation of the manufacturing product lots 220a, . . . , 220n, and 225 to the multiple units of manufacturing equipment 205a, . . . , 205n. Further the scheduling and dispatch function acts to coordinate the manufacturing execution system operator consoles 210a, . . . , 210n to insure maximum utilization of the multiple units of manufacturing equipment 205a, . . . , 205n.

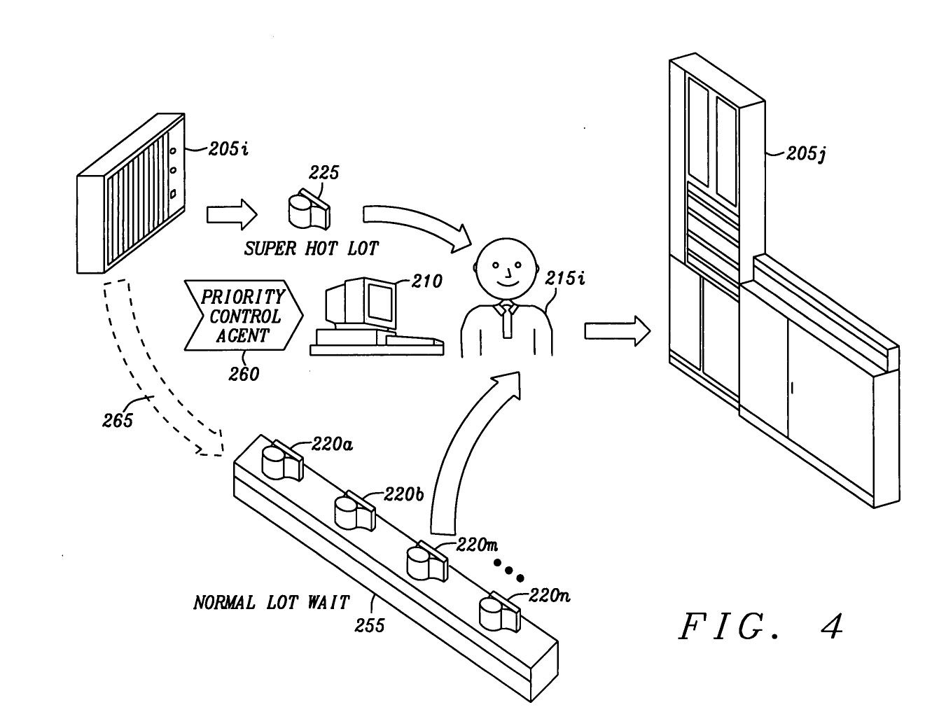

The CIM system 235 communicates, as shown in FIG. 4, a priority control agent or program 260 that controls run sequences of product lots to minimize low utilization rates of units of manufacturing processing equipment 205i and 205j. Under normal operation, the manufacturing product lots 220a, . . . , 220n are transferred 265 from a previous unit of the manufacturing equipment 205i, upon completion of processing, to the staging area or normal lot waiting area 255. The normal lot waiting area 255 is the location from which the operator 215i retrieves a next manufacturing product lot 220a, . . . , 220n that is to be processed by the current unit of the manufacturing equipment 205j. If the manufacturing execution system operator console 210i receives notification of the arrival of a high priority or super hot product lot 225 by way of the priority control agent 260, the operator begins processing next the manufacturing product lots 220a, . . . , 220n. When the super hot manufacturing product lot 225 arrives, the operator verifies the priority of the previous manufacturing product lot 220a, . . . , 220n placed in the unit of manufacturing equipment 205j. If the previous manufacturing product lot 220a, . . . , 220n has normal priority, the previous manufacturing product lot 220a, . . . , 220n is removed from the multiple units of manufacturing equipment 205j and the super hot lot manufacturing product lot 225 is processed. Upon completion of the processing of the super hot lot manufacturing product lot 225, the previous manufacturing product lot 220a, . . . , 220n is replaced in the current unit of manufacturing equipment 205j to complete processing. Of course, it is obvious to one skilled in the art, that the processing of the previous manufacturing product lot 220a, . . . , 220n must have a recipe that allows for interruption during the execution of the steps of the recipe. This would be, for instance, in a semiconductor foundry, where a sputtering unit operates on each individual wafer. Thus, at the completion of the sputtering process on an individual wafer, the lot being processed maybe removed from the sputtering unit and placed in a staging area waiting completion of the process. When the super hot lot of wafers is complete, the previous lot of wafers may be returned to the sputtering unit for completion of the processing of the wafers in the lot.

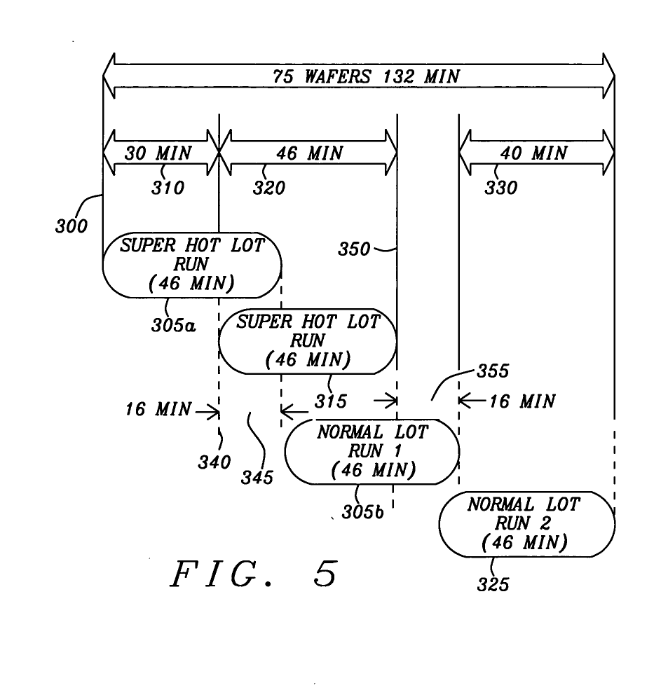

The advantage of the run sequence agent that controls the order and interruption of the processing of manufacturing product lots is shown in FIG. 5. At the time 300 the manufacturing execution system operator console is alerted by the CIM system that a super hot lot manufacturing product lot is being processed by a previous unit of manufacturing equipment, rather than holding the current unit of manufacturing equipment idle until the super hot manufacturing product lot arrives. The operator will initiate the processing 305a of a normal manufacturing product lot. The time 310 between the announcing the presence of a super hot manufacturing product lot and its arrival at the current unit of manufacturing equipment is 30 minutes in this example. The processing time of the previous manufacturing product lot is scheduled to be 46 minutes, however, the processing is suspended and the previous manufacturing product lot is removed from the unit of manufacturing equipment. The super hot manufacturing product lot is placed in the current unit of manufacturing equipment to begin processing 315 at the time 340 for a period of 46 minutes. The previous manufacturing product lot is placed in a staging area awaiting resumption of processing for the remaining time period 345 (16 minutes). At the completion of the processing of the super hot lot manufacturing product lot, the processing 305b of the normal manufacturing product lot resumes at the time 350 and requires the sixteen minutes 355 for the completion of the previous manufacturing product lot. As described above, an overlap of time wherein a next manufacturing product lot is placed in the current unit of manufacturing equipment and the previous manufacturing product lot is removed. The second normal manufacturing product lot is placed in the unit of manufacturing equipment and processing is begun 325. The previous manufacturing product lot is removed, the next manufacturing product lot continues, and at a time 40 minutes later 330 the next manufacturing product lot is completed. Thus there are 75 wafers of the product lot completed in 132 minutes. With the message alerting to the arrival of the super hot lot manufacturing product lot and the partial processing of the previous manufacturing product lot the utilization is effectively 100% for an increase in utilization of 19.2% over the example of the prior art. Further, the processing rate can be shown to be more than 34 wafers per hour This is an increase in production rate of more than six wafers per hour over the prior art.

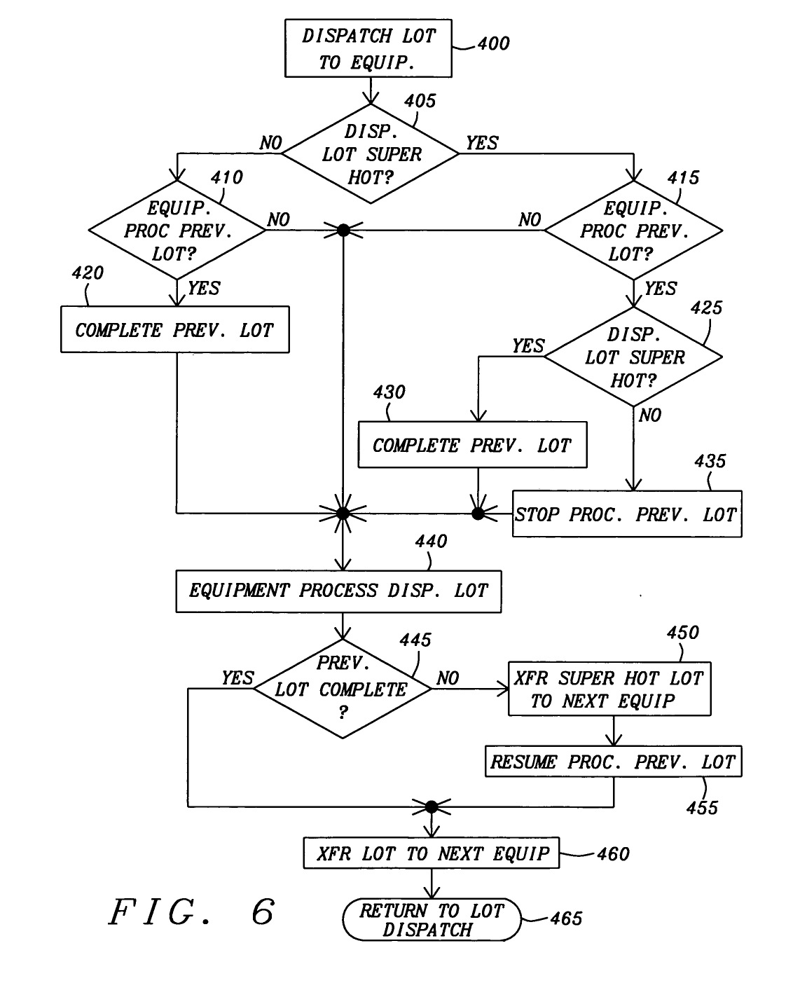

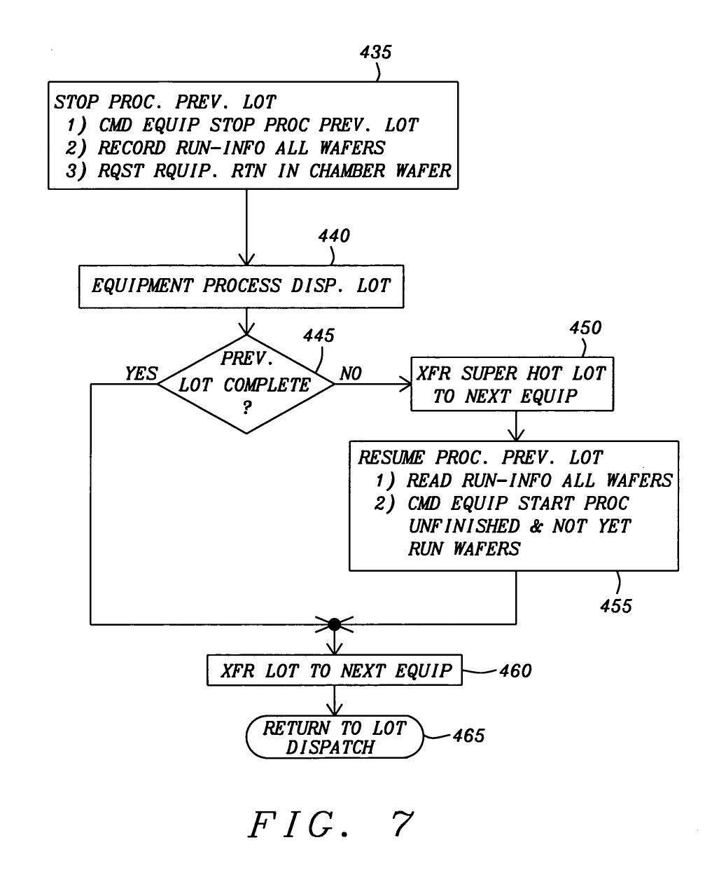

The manufacturing equipment scheduling sub-system of the CIM system provides the software agent that performs the function of the product lot sequence controller. The software agent is retained by a data retention device and when extracted by a computer of the CIM system, performs a program process that is described in FIGS. 6 and 7. The CIM system dispatches (Box 400) manufacturing product lots and the software agent as executed on the manufacturing execution system operator console examines (Box 405) the priority of the dispatched lots to determine whether the manufacturing product lot has a high priority. The software agent then examines (Box 410) the contents of the unit of manufacturing equipment to determine if a previous manufacturing product lot is still in process. If there is a previous manufacturing product lot in the unit of manufacturing equipment, the previous manufacturing product lot is completed (Box 420) and the currently dispatched normal manufacturing product lot is then processed (Box 440). Alternately, if there is no previous manufacturing product lot in the unit of manufacturing equipment, the currently dispatched normal manufacturing product lot is then processed (Box 440).

If the dispatched lot is determined (Box 405) to be a high priority or super hot lot, the software agent then determines (Box 415) if the unit of manufacturing equipment contains a previous manufacturing product lot. If the unit of manufacturing equipment does not contain a manufacturing product lot, the currently dispatched super hot lot manufacturing product lot is processed (Box 440). Alternately, if the unit of manufacturing equipment does contain a previous manufacturing product lot, the software agent must determine (Box 425) whether the previous manufacturing product lot has a high priority or is super hot. If the previous manufacturing product lot is super hot, the previous manufacturing product lot is processing is completed (Box 430). If the previous manufacturing product lot is not super hot and has a normal priority, processing of the previous manufacturing product lot is stopped (Box 435) and the previous manufacturing product lot is removed from the unit of manufacturing equipment and the super hot lot manufacturing product lot is processed (Box 440). Referring to FIG. 6, the stopping of the previous manufacturing product lot requires that the software agent command the unit of manufacturing equipment to cease processing of the previous manufacturing product lot. The run status information is then recorded and the previous manufacturing product lot (wafers in the silicon foundry example) is returned to the staging area.

Upon completion of processing (Box 440) the currently dispatched lot, the software agent must determine (Box 445) if the previous lot has competed processing. If the previous lot has not completed processing, as in the instance of the super hot lot processing, upon completion of processing (Box 440) of the currently dispatched manufacturing product lot, the currently dispatched manufacturing product lot is transferred (Box 450) to the next stage of the processing and the previous manufacturing product resumes processing (Box 455). Referring to FIG. 7, the resumption of the processing (Box 455) of the previous manufacturing product lot is accomplished by reading the run status information for all the product units (wafers) within the previous manufacturing product lot and then commanding the unit of manufacturing equipment to resume processing of all unfinished product units or product units that have not been processed.

Upon completion of the processing of the previous manufacturing product lot or if there is no previous manufacturing product lot, the manufacturing product lot completing processing is transferred (Box 460) to the next unit of manufacturing equipment. The action of the software agent is completed and returns (Box 465) to monitor the next manufacturing product lot dispatch.

The manufacturing equipment scheduling system of this invention employs a product lot sequence controller to avoid low utilization rates of the unit of manufacturing equipment, while reducing the cycle times for normal manufacturing product lots and minimizing excessive idle time. Further, when an operator mistakenly begins processing a normal manufacturing product lot when a super hot manufacturing product lot has arrived or is about to arrive, the product lot sequence controller controls which lots are processed. Processing of the previous normal manufacturing product lot is stopped and the super hot manufacturing product lot is processed. When the super hot manufacturing product lot is completed, the product lot sequence controller instructs the operator to complete the processing of the previous manufacturing product lot before starting the next normal manufacturing product lot.

While this invention has been particularly shown and described with reference to the preferred embodiments thereof, it will be understo product lot sequence controller product lot sequence controller od by those skilled in the art that various changes in form and details may be made without departing from the spirit and scope of the invention.

1. A manufacturing equipment scheduling system for controlling run sequences of product lots to minimize low utilization rates of units of manufacturing processing equipment employed in fabricating said product lots, comprising:
a product lot sequence controller in communication with a product lot dispatch system to receive priority information of the product lots dispatched for fabrication, and in communication with an operations controller to establish an order in which said product lots are processed by units of said processing equipment, said product lot sequence controller establishing said order by performing the steps of:
receiving a dispatch order for at least one current product lot,
determining a priority of said current product lot,
if said current product lot has a high priority, determining if a previous product lot remains in a selected unit of said processing equipment,
if said previous product lot remains in the selected unit of processing equipment, determining if said previous product lot is has a normal priority
if said previous product lot has a normal priority, removing said previous product lot from said selected unit of processing equipment,
processing the current product lot with the high priority; and
upon completion of processing said current product lot with high priority, continuing processing the previous product lot.

2. The manufacturing equipment scheduling system of claim 1 wherein the product lot sequence controller further establishes said order by performing the steps of:
if said current product lot has the normal priority, determining if the previous product lot remains in the selected unit of processing equipment;
if said previous product lot remains in the selected unit of processing equipment, continuing processing said previous product lot to completion; and
processing the current product lot with the normal priority.

3. The manufacturing equipment scheduling system of claim 1 wherein the product lot sequence controller further establishes said order by performing the steps of:
if said previous product lot remains in the selected unit of processing equipment, determining if said previous product lot has a high priority;
if said previous product lot has the high priority, continuing processing said previous product lot in said selected unit of processing equipment; and
upon completion of processing said previous product lot, processing the current product lot.

4. The manufacturing equipment scheduling system of claim 1 wherein performing the step of removing said previous product lot from said selected unit of processing equipment includes the steps of:
commanding said selected unit of processing equipment to cease processing said previous product lot;
recording status information of all pieces of product within said previous product lot, and
requesting said selected unit of processing equipment to return said previous product lot to a staging location.

5. The manufacturing equipment scheduling system of claim 4 wherein performing the step of continuing processing the previous product lot includes the step of:
examining the status information of all pieces of product within said previous product lot,
requesting said selected unit of processing equipment to acquire said previous product lot from the staging location; and
commanding said selected unit of processing equipment to continue processing said previous product lot.

6. The manufacturing equipment scheduling system of claim 1 further comprising:
a messaging facility connected to communicate messages between said product lot sequence controller, said units of said processing equipment, and said product lot dispatch system.

7. The manufacturing equipment scheduling system of claim 1 wherein said product lots are integrated circuit substrates and said units of said processing equipment are integrated circuit fabrication equipment.

8. A method for scheduling manufacturing equipment to control run sequences of product lots to minimize low utilization rates of units of manufacturing processing equipment employed in fabricating said product lots, comprising:
communicating with a product lot dispatch system to receive priority information of the product lots dispatched for fabrication;
communicating with an operations controller to establish an order in which said product lots are processed by units of said processing equipment; and
establishing said order by performing the steps of:
receiving a dispatch order for at least one current product lot,
determining a priority of said current product lot,
if said current product lot has a high priority, determining if a previous product lot remains in a selected unit of said processing equipment,
if said previous product lot remains in the selected unit of processing equipment, determining if said previous product lot has a normal priority;
if said previous product lot has a normal priority, removing said previous product lot from said selected unit of processing equipment,
processing the current product lot with the high priority; and
upon completion of processing said current product lot with high priority, continuing processing the previous product lot.

9. The method of claim 8 wherein establishing said order further performs the steps of:
if said current product lot has the normal priority, determining if the previous product lot remains in the selected unit of processing equipment;
if said previous product lot remains in the selected unit of processing equipment, continuing processing said previous product lot to completion; and
processing the current product lot with the normal priority.

10. The method of claim 8 wherein establishing said order further performs the steps of:
if said previous product lot remains in the selected unit of processing equipment, determining if said previous product lot has a high priority;
if said previous product lot has the high priority, continuing processing said previous product lot in said selected unit of processing equipment; and
upon completion of processing said previous product lot, processing the current product lot.

11. The method of claim 8 wherein performing the step of removing said previous product lot from said selected unit of processing equipment includes the steps of:
commanding said selected unit of processing equipment to cease processing said previous product lot;
recording status information of all pieces of product within said previous product lot, and
requesting said selected unit of processing equipment to return said previous product lot to a staging location.

12. The method of claim 11 wherein performing the step of continuing processing the previous product lot includes the steps of:
examining the status information of all pieces of product within said previous product lot,
requesting said selected unit of processing equipment to acquire said previous product lot from the staging location; and
commanding said selected unit of processing equipment to continue processing said previous product lot.

13. The method of claim 8 wherein communicating with a product lot dispatch system is performed by the step of:
transferring messages to and from said product lot dispatch system.

14. The method of claim 8 wherein communicating with an operations controller is performed by the step of:
transferring messages to and from said operations controller.

15. The method of claim 8 wherein said product lots are integrated circuit substrates and said units of said processing equipment are integrated circuit fabrication equipment.

16. An apparatus for scheduling manufacturing equipment to control run sequences of product lots to minimize low utilization rates of units of manufacturing processing equipment employed in fabricating said product lots, comprising:
means for communicating with a product lot dispatch system to receive priority information of the product lots dispatched for fabrication;
means for communicating with an operations controller to establish an order in which said product lots are processed by units of said processing equipment; and
means for establishing said order including:
means for receiving a dispatch order for at least one current product lot,
means for determining a priority of said current product lot,
means for determining if a previous product lot remains in a selected unit of said processing equipment, if said current product lot has a high priority,
means for determining if said previous product lot has a normal priority, if said previous product lot remains in the selected unit of processing equipment;
means for removing said previous product lot from said selected unit of processing equipment, if said previous product lot has a normal priority,
processing the current product lot with the high priority; and
means for continuing processing the previous product lot, upon completion of processing said current product lot with high priority.

17. The apparatus of claim 16 wherein means for establishing said order further includes:
means for determining if the previous product lot remains in the selected unit of processing equipment, if said current product lot has the normal priority;
means for continuing processing said previous product lot to completion, if said previous product lot remains in the selected unit of processing equipment, and
means for processing the current product lot with the normal priority.

18. The apparatus of claim 16 wherein means for establishing said order further includes:
means for determining if said previous product lot has a high priority, if said previous product lot remains in the selected unit of processing equipment;
means for continuing processing said previous product lot in said selected unit of processing equipment, if said previous product lot has the high priority; and
means for processing the current product lot, upon completion of processing said previous product lot.

19. The apparatus of claim 16 wherein means for removing said previous product lot from said selected unit of processing equipment comprises:
means for commanding said selected unit of processing equipment to cease processing said previous product lot;
means for recording status information of all pieces of product within said previous product lot, and
means for requesting said selected unit of processing equipment to return said previous product lot to a staging location.

20. The apparatus of claim 19 wherein means for continuing processing the previous product lot comprises:
means for examining the status information of all pieces of product within said previous product lot,
means for requesting said selected unit of processing equipment to acquire said previous product lot from the staging location; and
means for commanding said selected unit of processing equipment to continue processing said previous product lot.

21. The apparatus of claim 16 wherein said means for communicating with a product lot dispatch system comprises:
means for transferring messages to and from said product lot dispatch system.

22. The apparatus of claim 16 wherein said means for communicating with an operations controller includes:
means for transferring messages to and from said operations controller.

23. The apparatus of claim 16 wherein said product lots are integrated circuit substrates and said units of said processing equipment are integrated circuit fabrication equipment.

24. A computer integrated manufacturing system that executes a program process for controlling run sequences of product lots to minimize low utilization rates of processing equipment manufacturing unit employed in fabricating said product lots, the program process comprising the steps of:
communicating with a product lot dispatch system to receive priority information of the product lots dispatched for fabrication;
communicating with an operations controller to establish an order in which said product lots are processed by units of said processing equipment; and
establishing said order of performing the steps of:
receiving a dispatch order for at least one current product lot,
determining a priority of said current product lot,
if said current product lot has a high priority, determining if a previous product lot remains in a selected unit of said processing equipment,
if said previous product lot remains in the selected unit of processing equipment, determining if said previous product lot is has a normal priority;
if said previous product lot has a normal priority, removing said previous product lot from said selected unit of processing equipment,
processing the current product lot with the high priority; and
upon completion of processing said current product lot with high priority, continuing processing the previous product lot.

25. The computer integrated manufacturing system of claim 24 wherein the step of said program process for establishing said order further performs the steps of:
if said current product lot has the normal priority, determining if the previous product lot remains in the selected unit of processing equipment;
if said previous product lot remains in the selected unit of processing equipment, continuing processing said previous product lot to completion; and
processing the current product lot with the normal priority.

26. The computer integrated manufacturing system of claim 24 wherein the step of said program process for establishing said order further performs the steps of:
if said previous product lot remains in the selected unit of processing equipment, determining if said previous product lot has a high priority;
if said previous product lot has the high priority, continuing processing said previous product lot in said selected unit of processing equipment; and
upon completion of processing said previous product lot, processing the current product lot.

27. The computer integrated manufacturing system of claim 24 wherein the step of said program process for performing the step of removing said previous product lot form said selected unit of processing equipment includes the step of:
commanding said selected unit of processing equipment to cease processing said previous product lot;
recording status information of all pieces of product within said previous product lot, and
requesting said selected unit of processing equipment to return said previous product lot to a staging location.

28. The computer integrated manufacturing system of claim 27 wherein the step of said program process for performing the step of continuing processing the previous product includes the steps of:
examining the status information of all pieces of product within said previous product lot,
requesting said selected unit of processing equipment to acquire said previous product lot from the staging location; and
commanding said selected unit of processing equipment to continue processing said previous product lot.

29. The computer integrated manufacturing system of claim 24 wherein the step of said program process for communicating with a product lot dispatch system includes the step of:
transferring messages to and from said product lot dispatch system.

30. The computer integrated manufacturing system of claim 24 wherein the step of said program process for communicating with an operations controller is performed by the step of:
transferring messages to and from said operations controller.

31. The computer integrated manufacturing system of claim 24 wherein said product lots are integrated circuit substrates and said units of said processing equipment are integrated circuit fabrication equipment.

32. A medium for retaining a computer program which, when executed by a computing system, implements a program process for controlling run sequences of product lots to minimize low utilization rates of units of manufacturing process equipment equipment employed in fabricating said product lots, the program process comprising the steps of:
communicating with a product lot dispatch system to receive priority information of the product lots dispatched for fabrication;
communicating with an operations controller to establish an order in which said product lots are processed by units of said processing equipment; and
establishing said order by performing the steps of:
receiving a dispatch order for at least one current product lot,
determining a priority of said current product lot,
if said current product lot has a high priority, determining if a previous product lot remains in a selected unit of said processing equipment,
if said previous product lot remains in the selected unit of processing equipment, determining if said previous product lot is has a normal priority;
if said previous product lot has a normal priority, removing said previous product lot from said selected unit of processing equipment,
processing the current product lot with the high priority; and
upon completion of processing said current product lot with high priority, continuing processing the previous product lot.

33. The medium of claim 32 wherein the step of said program process for establishing said order further performs the steps of:
if said current product lot has the normal priority, determining if the previous product lot remains in the selected unit of processing equipment;
if said previous product lot remains in the selected unit of processing equipment, continuing processing said previous product lot to completion; and
processing the current product lot with the normal priority.

34. The medium of claim 32 wherein the step of said program process for establishing said order further performs the steps of:
if said previous product lot remains in the selected unit of processing equipment, determining if said previous product has a high priority;
if said previous product lot has the high priority, continuing processing said previous product lot in said selected unit of processing equipment; and
upon completion of processing said previous product lot, processing the current product lot.

35. The medium of claim 32 wherein the step of said program process for performing the step of removing said previous product lot from said selected unit of processing equipment includes the step of:
commanding said selected unit of processing equipment to cease processing said previous product lot;
recording status information of all pieces of product within said previous product lot, and
requesting said selected unit of processing equipment to return said previous product lot to a staging location.

36. The medium of claim 35 wherein the step of said program process for performing the step of continuing processing the previous product lot includes the steps of:
examining the status information of all pieces of product within said previous product lot,
requesting said selected unit of processing equipment to acquire said previous product lot from the staging location; and
commanding said selected unit of processing equipment to continue processing said previous product lot.

37. The medium of claim 32 wherein the step of said program process for communicating with a product lot dispatch system is performed by the step of:
transferring messages to and from said product lot dispatch system.

38. The medium of claim 32 wherein the step of said program process for communicating with an operations controller is performed by the step of:
transferring messages to and from said operations controller.

39. The medium of claim 32 wherein said product lots are integrated circuit substrates and said units of said processing equipment are integrated circuit fabrication equipment.
